(19) United States
(12) Patent Application Publication
(10) Pub. No.: US 2002/0020987 A1
(43) Pub. Date: Feb. 21, 2002

(54) Wheelchair

(76) Inventor: Eupha Coleman, Petersburg, AK (US)

Correspondence Address: Michael Tavella, 2051 Brigadier Dr., Anchorage, AK, 99507, US

(21) Appl. No.: 09/904,491

(22) Filed: Jul. 13, 2001

Related U.S. Application Data
(60) Provisional application No. 60/221,466, filed on Jul. 26, 2000.

(51) Int. Cl. B62J 1/00

(52) U.S. Cl. 280/304.1; 280/288.4

(57) ABSTRACT

A transfer chair with wheels that has a removable back portion, a removable arm rest portion, a seat portion having a removable insert, a leg carrying portion, a wheeled base portion and a lifting mechanism. The removable back portion allows that the transfer chair be positioned flat onto a mattress, so a patient can roll or be rolled onto it. The seat portion has a plug that is removable to expose an opening in the seat that allows waste to pass therethrough for toilet use by a patient. The leg-carrying portion holds the seat portion of the proper height and provides support for the seat portion. The wheeled base portion has front wheels that allow the transfer chair to fit under a standard bed frame.

### CROSS REFERENCE TO RELATED APPLICATIONS

Not Applicable

### BACKGROUND OF THE INVENTION

1. Field of the invention

This invention relates to wheelchairs, and specifically to wheelchairs that allow the transfer of a patient without lifting.

2. Description of the Prior Art

Wheelchairs have traditionally been used for transporting immobile persons. Getting the person into the wheelchair has been a dreadful procedure, causing stress and oftentimes injury to both care provider and patient.

The most common method of transfer has been that of bodily lifting. This has advanced to the use of a belt, which when tied around the patients waist gives the person performing the transfer something to hold onto.

The other advancement for bodily lifting is the use of lift teams. This and the transfer belt are used around the clock in hospitals, nursing homes and private care facilities. The lift team involves two or more persons to do the lift, if they are not of equal strength, height or coordinated someone is likely to get hurt. It is a backbreaking procedure however it is approached.

A board is sometimes used to slide a person from a bed to the chair or the chair to a car. The skin of an invalid is tender; sliding creates friction, which can cause abrasion and bruising.

Some lift mechanisms operate like a crane. A heavy canvas cloth, which has holes along the sides for clamps that attach to chains, is placed under the patient. When this has been arranged the patient is lifted by being jacked up then swung over to the chair. It is cumbersome, embarrassing and dangerous. It is however, the only method for lifting a heavy person who has fallen on the floor and is sometimes used for transporting a corpse. The crane type mechanism is a helpful device but because of its awkward size and the time involved in setting it up it cannot serve the general transfer problem.

It is also known that frequent repositioning, especially from the bed to the chair helps improve blood and fluid circulation. Increased circulation is vital for the prevention of decubitus ulcers or bedsores. Increased circulation helps diabetics, decreases edema and helps all persons have better bowel function.

Additionally, patients with osteoporosis need special care when being moved because their bones are fragile and can easily be broken.

Getting a patient out of the confines of a bed helps them mentally and emotionally, thus stimulating the immune system. They can socialize and not feel secluded from a larger environment.

These are some of the advantages of an easier transfer method for non-locomotive persons.

Another great advantage is that the rear entry transfer wheelchair easily slides over a toilet. A panel in the top seat is removable exposing a comfortable toilet seat. This avoids a transfer from a conventional wheelchair to the toilet or portable commode.

Another area of concern is the stress on the care provider caused by lifting patients. In nursing homes or other facilities where immobile patients need to be moved front bed to toilet or the like, it is now required that the patient be lifted by an attendant from a prone position and them hoisted somehow to a wheelchair. The wheelchair is then transported to a toilet whereupon the patient is again lifted onto the toilet seat. Consequently, in long-term heath care facilities, back injuries are epidemic. Nurse's aides, who provide most patient care particularly at risk. Back injuries account for 43 percent of all injuries in nursing homes, while they account for just 25 percent in the private sector. Nursing homes have the highest rate of occupational illness and injury and the highest rate of lost workdays.

Thus, there is a need for a device that can better transport and move patients from beds to facilities, such as toilets, and back again that is not harmful to the patient and makes moving the patient less of a burden for the healthcare provider.

Many Patents have been issued to aid in this process. Some examples are found in the following U.S. Patents: U.S. Pat. No. 2,903,238 to Flandrick discloses an invalid lifting and transporting apparatus having small rear wheels. U.S. Pat. No. 4,555,121 to Lockard, et al. discloses an invalid's chair, which facilitates transfer to a car. The front wheels of the chair can be rolled beneath the undercarriage of the car. U.S. Pat. No. 4,669,943 to Zamotin discloses a wheelchair for transferring a patient to a motor vehicle. The support for the chair is rotatable on the wheeled chassis so that the chair can be rotated into alignment with the seat of an automobile. U.S. Pat. No. 4,737,991 to Lanson discloses a patient transfer device that uses a seat, a conveyor, and various steps for moving a patient. U.S. Pat. No. 5,112,076 to Wilson discloses a wheelchair with a removable seat. When moving a patient, the wheels of the wheelchair in Wilson are positioned adjacent to a bed. U.S. Pat. No. 5,255,934 to Wilson discloses a wheelchair seat that is convertible to a toilet seat so that the patient does not have to be removed from the chair to use a toilet. U.S. Pat. No. 5,333,333 to Mah discloses a transportation, sanitation and therapy system for handicapped people. The Mah device facilitates positioning a patient in a variety of positions including standing. U.S. Pat. No. 5,966,750 to Polanco discloses a chair for washing disabled individuals, which has a rotatable seat that allows the caregiver to swivel the seat to a number of positions.

### BRIEF SUMMARY OF THE INVENTION

The wheelchair and transfer chair of the present invention fulfills the lift requirement and the role of a traditional wheelchair. The transfer chair with wheels of the present invention generally comprises a removable back portion, a removable arm rest portion, a seat portion having a removable insert, a leg carrying portion, a wheeled base portion and a lifting mechanism. The removable back portion allows that the transfer chair be positioned flat onto a mattress, so a patient can roll or be rolled onto it instead of being lifted onto it. The removable arm rest portion is integrally connected to the back portion. The seat portion has a plug that is removable to expose an opening in the seat that allows waste to pass therethrough for toilet use by a patient. The leg-carrying portion holds the seat portion of the proper height and provides support for the seat portion. The wheeled base portion has front wheels that rotate 360 degrees to allow turning of the transfer chair and rear wheels that fit under a standard bed frame. The lifting mechanism lifts the seat portion of the transfer chair between the height of a toilet and the height of a mattress.

This device is novel in that it uses a rear entry approach to the bed, has a removable back and a toilet seat. The legs have an extended length providing a perfect weight-ratio balance, making it virtually tipless with proper use.

As mentioned above, the rear entry transfer wheelchair easily slides over a toilet. The top seat is removable exposing a comfortable toilet seat. This avoids a transfer from a conventional wheelchair to the toilet or portable commode.

A typical embodiment of the rear entry transfer chair has a frame with four wheels. The two front wheels each have a swivel brake lock. A front cross brace is connected to leg frame. A frame base seat with opening for toilet use is welded along the entire surface of the horizontal top plane of the left and right frame legs. A slot to lock the seat back is welded onto the side of frame base. The top seat is made of plywood and padded with sturdy waterproof vinyl. The top seat has a separate piece that pulls out, leaving the toilet opening exposed.

The operation of the rear entry wheelchair is as follows: for a patient lying in bed, turn the patient on their side facing away from the chair. With the seat back off, roll the U shaped frame up to the bed. The rear wheels slide under the bed. The seat rests on the mattress in alignment with the patient's buttocks. Next, lock the brakes. Then gently roll the patient back to a prone position. Now the patient is laying face upward with their buttocks on the seat. Then, place an arm under the thoracic region of their back and gently help them tilt forward, at the same time putting your other hand on their thigh, starting to move their legs over the side of the bed. Their body now becomes a natural fulcrum and they are sitting on the seat of the chair. Then, place the removable seat back around their back and lock it into place. Next, raise the footrest to a comfortable position. Finally, unlock the brake and pull the chair away from the bed. The patient is safely seated, ready to go, no strain or injury to either care provider or patient.

### BRIEF DESCRIPTION OF THE DRAWINGS

FIG. 1 shows an overall view of the basic transfer chair.

FIG. 2 shows the removable seat back and side view of the arm attachments.

FIG. 3 shows the frame base, wheels, legs and bottom seat.

### DETAILED DESCRIPTION OF THE INVENTION

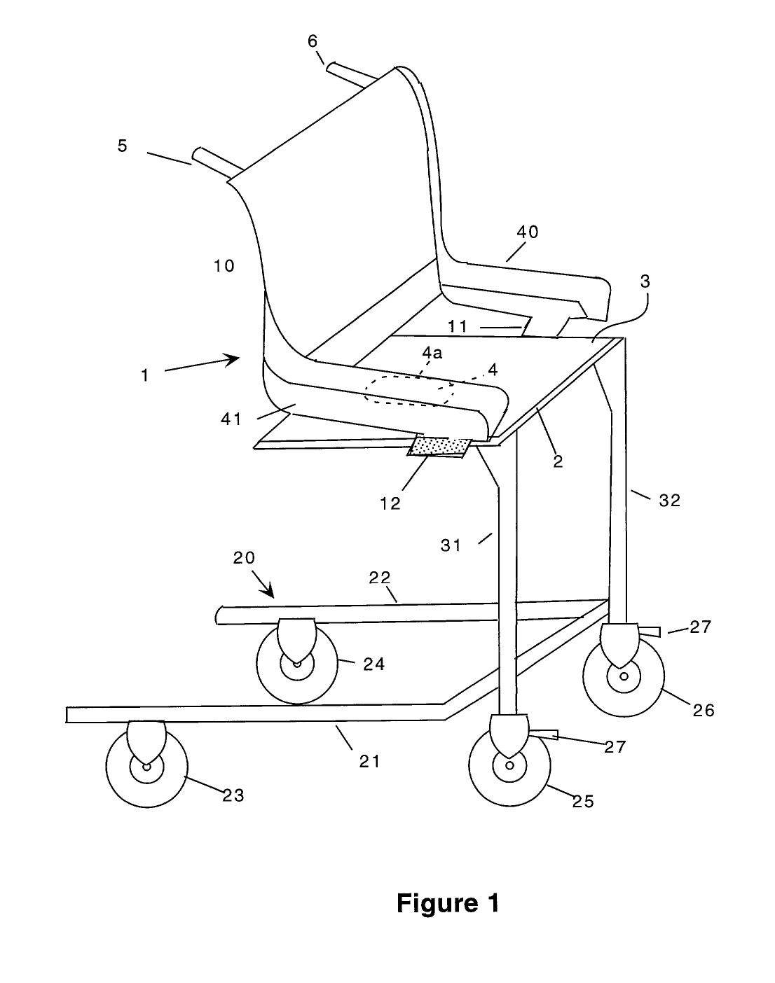

Referring now to FIG. 1, one embodiment of the rear entry transfer chair 1 is shown. FIG. 1 shows a top seat 2. In the preferred embodiment, the seat top is made of plywood but can be made from any suitable material. The top of the seat 2 is padded and is covered with sturdy waterproof vinyl 3.

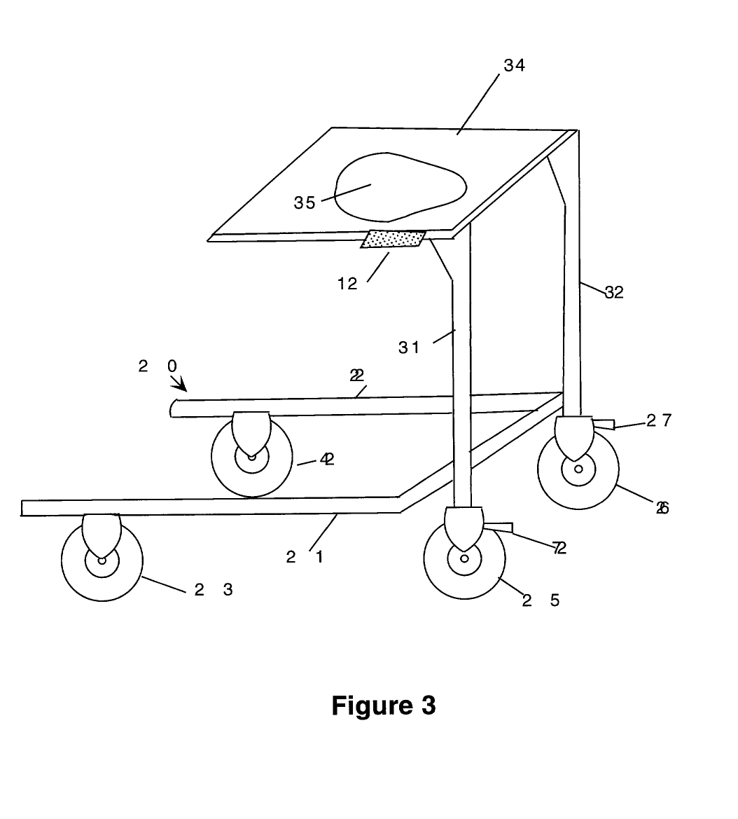

As shown, the top seat 2 has in inner plug piece 4 that pulls out the seat to form the toilet opening 15 (see FIG. 3).

FIG. 1 also shows the right and left handle grip 5 and 6 that are covered with non-slip rubber. The shape of these grips is not limited to this design, but may possibly be curved downward, for example. The chair has a pair of footrests (not shown); these footrests are similar to ordinary wheel chairs. Two armrests 40 and 41 are attached to the chair back as shown.

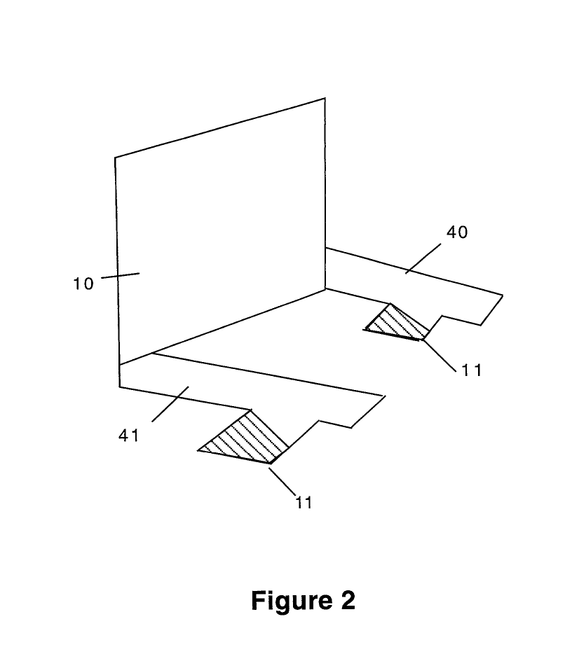

FIG. 2 shows the chair back 10 and the left and right armrest strut 11 that fits into locking slot 12. FIG. 2 also shows the chair back 10, which is attached to the armrests 40 and 41. This design allows for the easy removal of the chair back, as discussed below.

FIG. 3 shows the bottom of the chair 1 has a frame 10 that has four wheels 23, 24, 25, and 26 attached. The two front wheels 25 and 26 have each a swivel brake lock 27 to lock the chair in place. The rear wheels 23 and 24 are made of non-skid rubber. The wheels are bolted into the frame legs 21 and 22. The frame 20 is preferably made of steel, stainless steel, titanium, carbon fiber, or aluminum but can be made from any weight bearing substance, such as, heavy-duty plastics, wood, etc. As shown in FIG. 1, a front cross brace 30 is connected to leg frames 21 and 22. The cross member also attaches to two vertical members 31 and 32 as shown.

A frame seat base 34 with opening 35 for toilet access is welded to the top of the frame along the entire surface of the of the left and right frame legs 31 and 32, which curve under the seat base to form a support platform. The vinyl covered plywood seat 2 is attached to the frame seat base 34. Note that the opening 4a in the vinyl covered plywood seat 2 aligns with the whole 15 in the frame seat base so that the chair can be used for toilet use.

FIG. 3 also shows the locking slot 12 for the seat 2 is welded onto the side of frame base as discussed above.

The frame 20 can be painted according to choice with top grade washable paint.

The toilet feature allows an individual to go to homes and other public places and perform toilet duties in an easier less stressful manner.

Accouterments such as a vibrating seat back, spaces for heat pads, satchels, backpacks, headrest and a tray table for writing, eating or crafts can also be added as desired.

The operation of the rear entry wheelchair is as follows: in the case of a patient lying in bed, the patient is turned on their side facing away the chair. With the seat back off, (see FIG. 2), the U shaped frame is positioned near the bed. The rear wheels are then slid under the bed until the seat rests on the mattress and is in alignment with the patient's buttocks. Next, the brakes on the front wheels are locked. Then the patient is rolled back to a prone position. Now the patient is laying face upward with their buttocks on the seat. Then the patient is gently tilted forward at the same time as their legs are moved over the side of the bed. Their body now becomes a natural fulcrum and, because of this maneuver, they end up sitting on the seat of the chair. Next the removable seat back is placed around their back and locked it into place. Then the footrest is raised to a comfortable position. Finally, the brakes are unlocked and the chair is ready to be pulled away from the bed.

The present disclosure should not be construed in any limited sense other than that limited by the scope of the claims having regard to the teachings herein and the prior art being apparent with the preferred form of the invention disclosed herein and which reveals details of structure of a preferred form necessary for a better understanding of the invention and may be subject to change by skilled persons within the scope of the invention without departing from the concept thereof.

I claim:

1. A transfer chair comprising:
a) a lower frame;
b) a seat portion having a removable insert, said seat portion being attached to said lower frame; and
c) a removable back portion, removably attached to said seat portion.

2. The transfer chair of claim 1 further comprising: a plurality of wheels, attached to said lower frame.

3. The transfer chair of claim 2 further comprising a means for temporarily locking said plurality of wheels into a fixed position.

4. The transfer chair of claim 1 further comprising a pair of armrests, attached to said removable back portion.

5. The transfer chair of claim 1 further comprising a means for securing said removable back portion to said seat portion.

6. A transfer chair comprising:
a) a lower frame, said lower frame forming a U shaped member;
b) a seat portion, being attached to said lower frame, said seat portion having an opening therein position in said seat portion to permit a user to pass waste through said opening into a toilet positioned below said transfer chair; and
c) a removable back portion, removably attached to said seat portion.

7. The transfer chair of claim 6 wherein the U-shaped member has a lower frame portion, a pair of vertical members, attached to said lower frame portion, and an upper frame portion, attached to said pair of vertical members.

8. The transfer chair of claim 7 further comprising: a plurality of wheels, attached to said lower frame portion.

9. The transfer chair of claim 8 further comprising a means for temporarily locking said plurality of wheels into a fixed position.

10. The transfer chair of claim 6 further comprising a pair of armrests, attached to said removable back portion.

11. The transfer chair of claim 6 further comprising a means for securing said removable back portion to said seat portion.

12. The method of moving a patient from a bed to a transfer chair having a U-shaped lower frame; a rear pair of wheels and a front pair of wheels, attached to said U-shaped lower frame; a means for temporarily locking the front pair of wheels into a fixed position; a seat portion, being attached to said U- shaped lower frame, said seat portion having an opening therein position in said seat portion to permit a user to pass waste through said opening into a toilet positioned below said transfer chair; and a removable back portion, removably attached to said seat portion; comprising the steps of:
a) turning the patient onto their side, facing away from the transfer chair;
b) removing the removable back portion from the transfer chair;
c) rolling the U-shaped lower frame up to the bed such that the rear pair of wheels slide under the bed and the seat portion rests on the bed mattress in alignment with the patient's buttocks;
d) engaging said means for temporarily locking said front pair of wheels;
e) gently rolling the patient back to a prone position, such that the patient is laying face upwards with their buttocks on the seat portion;
f) placing an arm under the patient's thoracic region of the patient's back and gently helping the patient tilt forward, while simultaneously putting your other hand on their thigh, starting to move the patient's legs over the side of the bed until the patient is sitting on the seat portion of the transfer chair;
g) replacing the removable back portion around the patient's back; and
h) disengaging said means for temporarily locking said front pair of wheels, to pull the transfer chair away from the bed.

13. The method of claim 12 further comprising the steps of:
a) moving the patient to a toilet facility;
b) positioning the transfer chair over a toilet such that the opening in said seat portion is positioned above said toilet; and
c) allowing said patient to use said toilet facility.

14. The method of claim 12 further comprising the step of: placing a removable plug in said opening in said seat portion before placing the patient onto said transfer chair.
